(19) United States
(12) Patent Application Publication
(10) Pub. No.: US 2012/0329412 A1
(43) Pub. Date: Dec. 27, 2012

(54) APPARATUS AND METHOD FOR SEARCHING RADIO FREQUENCY IN RADIO RECEIVER

(75) Inventor: Young-Suk KIM, Seoul (KR)

(73) Assignee: SAMSUNG ELECTRONICS CO., LTD., Gyeonggi-Do (KR)

(21) Appl. No.: 13/466,712

(22) Filed: May 8, 2012

(30) Foreign Application Priority Data
Jun. 21, 2011 (KR) 10-2011-0060259

(51) Int. Cl. H04B 1/18

(52) U.S. Cl. 455/154.2; 455/161.1

(57) ABSTRACT

An apparatus and a method for searching for a radio frequency in a radio receiver are provided. A received broadcast signal is analyzed to determine if it has an abnormal waveform. If the abnormal waveform is detected, a fundamental radio frequency corresponding to the abnormal waveform is detected. The user of the radio receiver may then tune to the detected fundamental radio frequency. The abnormal waveform may have been transmitted by another radio receiver and serve as an indication of the radio frequency to which the other radio receiver is currently tuned. Thus, embodiments of the present invention serve as a way to share radio information among different radio receivers. The abnormal signal may have been derived from the radio frequency signal to which the other radio receiver was tuned. The abnormal waveform may be a clipped version of the original radio signal.

### CLAIM OF PRIORITY

This application claims the benefit to a Korean patent application filed in the Korean Intellectual Property Office on Jun. 21, 2011 and assigned Serial No. 10-2011-0060259, the entire disclosure of which is hereby incorporated by reference.

### BACKGROUND

1. Technical Field

The present disclosure relates generally to a radio receiver, and more particularly, to an apparatus and a method for searching for a radio frequency in a radio receiver.

2. Description of the Related Art

Generally, a plurality of radio stations broadcast various programs via corresponding channels, using an analog frequency division multiplexing (FDM) technique. Each channel occupies a predetermined bandwidth allocated to the corresponding radio station.

A radio receiver receives and reproduces a radio broadcast signal transmitted from a radio station via a frequency selected by a user. That is, the radio receiver has a tuner for turning a frequency to a frequency band selected by the user to receive and output only a radio broadcast signal of the frequency band selected by the user.

When the user of the radio receiver desires to listen to a program that is popular to other listeners, the user typically scans stations one by one, makes verbal inquiries to friends, etc., or does other research to learn which stations contain the type of programming desirable to the user and to the other listeners

### SUMMARY

An aspect of the present disclosure is to provide an apparatus and a method for searching for a radio frequency in a radio receiver.

Another aspect of the present disclosure is to provide an apparatus and a method in a radio receiver for searching for a radio frequency channel that is popular to other listeners.

Still another aspect of the present disclosure is to provide an apparatus and a method in a radio receiver for automatically searching for radio frequency channels that are generally popular or currently listened to by others.

An apparatus and a method for searching for a radio frequency in a radio receiver are provided. A received broadcast signal is analyzed to determine if it has an abnormal waveform. If the abnormal waveform is detected, a fundamental radio frequency corresponding to the abnormal waveform is detected. A user of the radio receiver may then tune to the detected fundamental radio frequency.

The abnormal waveform may have been transmitted by another radio receiver and serve as an indication of the radio frequency to which the other radio receiver is currently tuned. Thus, embodiments of the present invention serve as a way to share radio information among different radio receivers.

The abnormal signal may have been derived from the radio station signal received by the other radio receiver, i.e., at the frequency currently tuned in the other receiver. The abnormal waveform may be a clipped version of the original radio station signal. The clipped version may include only negative portions, such as negative halves, of the original radio signal, while the positive portions are used to reproduce the radio signal.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings in which:

FIG. 1 is a flowchart illustrating a procedure for receiving a radio signal in a radio receiver according to an exemplary embodiment of the present invention;

FIG. 2 is a flowchart illustrating a procedure for searching for a radio frequency in a radio receiver according to an exemplary embodiment of the present invention;

FIG. 3 is a block diagram illustrating a radio receiver according to an exemplary embodiment of the present invention; and

FIG. 4A depicts radio signal waveforms at different frequencies; and

FIG. 4B illustrates dividing a received radio signal into positive and negative portions, where the negative portions may be used as at least part of an abnormal waveform to be transmitted according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

Exemplary embodiments of the present invention provide a technology for searching for a radio frequency in a radio receiver.

In the following description, the radio receiver can be embodied as any one of a Personal Digital Assistant (PDA) having a radio tuner therein, a laptop, a smart phone, a netbook, a Mobile Internet Device (MID), a Ultra Mobile PC (UMPC), a Tablet Personal Computer (PC), a mobile communication terminal, and so forth.

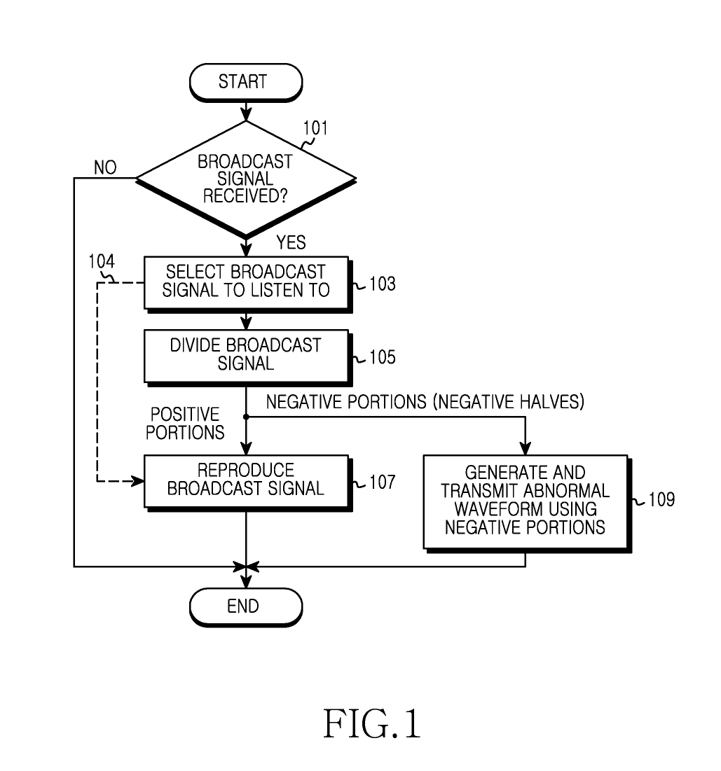

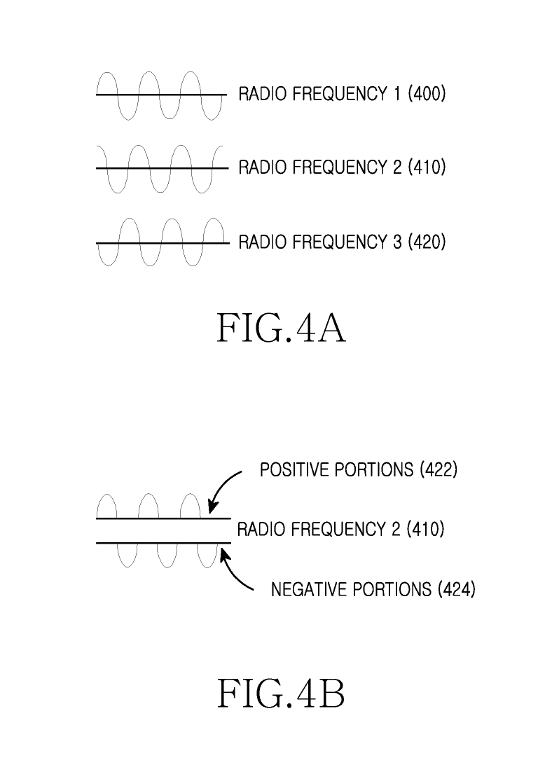

FIG. 1 is a flowchart illustrating an example procedure for receiving a radio signal in a radio receiver according to an exemplary embodiment of the present invention. In step 101, the radio receiver determines whether broadcast signals including radio broadcast information are received. When broadcast signals are received, the radio receiver proceeds to step 103 to detect only a signal of a frequency selected by a user from the broadcast signals (i.e., the receiver filters out signals outside the desired frequency band). For example, as illustrated in FIG. 4A, the radio receiver may receive broadcast signals of a radio frequency 1 410, a radio frequency 2 420, and a radio frequency 3 430. When a user of the radio receiver desires to listen to the radio frequency 2 420, the radio receiver tunes a bandpass filter in the receiver to the radio frequency 2 420 using a tuner to detect broadcast signals of the radio frequency 2 420.

The radio receiver next proceeds to step 105 to divide the broadcast signals detected in step 103 into positive portions (i.e., positive voltages or currents) and negative portions (i.e., negative voltages or currents). (Positive and negative “portions” of waveforms herein will be interchangeably referred to as positive and negative “peaks” of the waveforms, where positive peaks occur during positive half cycles and negative peaks occur during negative half cycles.) For example, the radio receiver divides an analog signal of the radio frequency 2 420 into positive portions 422 and negative portions 424 based on a direct current (DC) as illustrated in FIG. 4B. A waveform as 422 with only positive portions or peaks results in a net positive voltage, whereas a negative portions waveform as 424 results in a net negative voltage. Examples of receiver circuits that can be used to obtain these types of waveforms include a half wave rectifier, or a Class B, Class C or Class AB amplifier.

The positive portions can be obtained by extracting the top halves (top 50%) of the sinusoidal waveform, as depicted in FIG. 4B, e.g., using a half wave rectifier or Class B amplifier. Alternatively, more or fewer than 50% of the waveform can be extracted. By using a Class AB amplifier, more than 50% can be extracted. By using a Class C amplifier, less than 50% is extracted. The same principle applies for the extraction of the negative portions; however, suitable inverting circuitry or the like is needed to extract the negative peaks of the waveform instead of the positive peaks.

As another example to obtain a waveform with only the negative peaks, the received radio signal can be split into two paths, with a first path feeding a Class A amplifier to amplify both positive and negative halves of the signal, and a second path feeding a Class B or Class C amplifier to provide only positive amplified portions of the signal. The Class A output can be split up, with one portion used to reproduce the radio signal, and another portion fed to the input of a subtracter. The Class B or Class C amplifier output is supplied to another input of the subtracter. The subtracter then subtracts the Class B or C signal from the Class A signal, thereby deriving the waveform with only negative peaks.

After dividing the broadcast signal of the radio frequency to be listened to into the positive portions and the negative portions, the radio receiver proceeds to step 107 to reproduce the radio broadcasting using the positive portions of the broadcast signal.

In an alternative implementation, step 105 can be bypassed in the signal reproduction process, as indicated by path 104. In this case, the radio signal at the selected broadcast frequency can be reproduced in step 107 in a conventional manner, i.e., by using both the positive and negative parts of the waveform for reproduction.

In addition, after dividing the broadcast signal of the selected radio frequency in step 105, the receiver also performs step 109. That is, the radio receiver generates an abnormal waveform using the negative portions extracted from the radio signal at the selected frequency, and transmits the abnormal waveform from the radio receiver. The abnormal waveform can resemble that of waveform 424 of FIG. 4B, which has a fundamental frequency that is the same as the selected frequency, i.e., the same frequency of the radio station to which the user is currently listening. Alternatively, a different waveform can be derived from the waveform comprising the negative peaks, as long as the abnormal waveform has a fundamental frequency that is the same as the user selected frequency.

The transmitted abnormal waveform can then be received by other radio receivers equipped to detect this type of abnormal waveform. The abnormal waveform need not be modulated. When another radio receiver receives the abnormal waveform, that receiver is provided with information as to what stations another listener (i.e., the listener of the radio receiver transmitting the abnormal waveform) is tuned to. Users of the other radio receivers can then use this information in their own selection process, as will be described below. In an alternative embodiment, instead of using the negative portions to generate the abnormal waveform, the positive portions can be used, so long as the abnormal waveform is one that has a fundamental (carrier) frequency which is the same as the selected frequency.

When transmitting the abnormal signal, a filter may be used to filter out the fundamental frequency and transmit only harmonics of the current radio signal and thereby avoid interference with the radio signal being received and reproduced.

As described above, the radio receiver generates and transmits an abnormal waveform using the negative portions of the radio signal detected at the selected frequency. The abnormal waveform has the same fundamental frequency as the relevant (selected) radio frequency, but is distorted. (A signal such as shown in FIG. 4B is inherently considered distorted, as compared to a purely sinusoidal signal. The fundamental frequency of each of the positive and negative portions waveforms 422 and 424 of FIG. 4B is the same as that of FIG. 4A.)

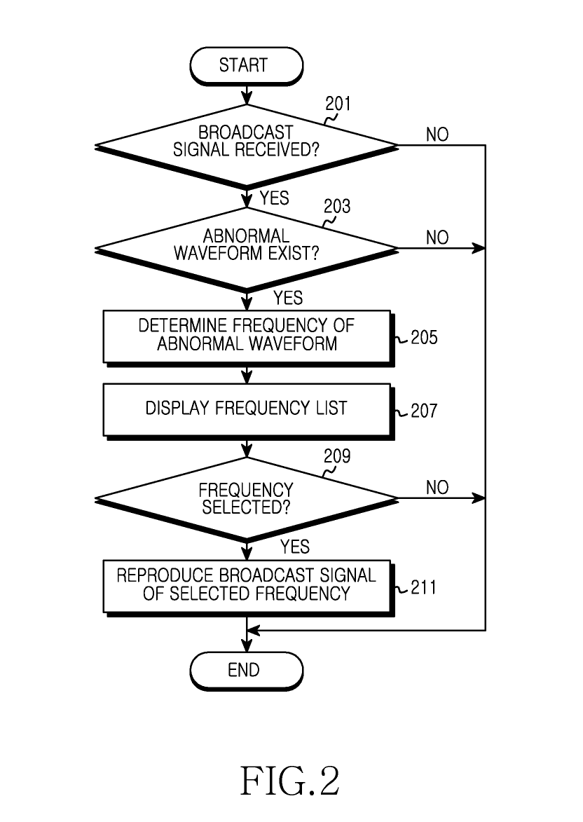

The radio receiver may detect negative portions transmitted by a different radio receiver in a similar or identical fashion. The radio receiver user can then determine a radio frequency that the different radio receiver is listening to, as illustrated by the method of FIG. 2.

FIG. 2 is a flowchart illustrating a procedure for searching for a radio frequency in a radio receiver according to an exemplary embodiment of the present invention. In step 201, the radio receiver determines whether broadcast signals including radio broadcast information are received.

When the broadcast signals are received, the radio receiver determines in step 203 whether a signal having an abnormal waveform has been received. For example, the radio receiver determines whether a signal with a predetermined distortion characteristic has been received. One example, as described above, is a signal having only negative portions (negative peaks) of a fundamental frequency in the operational radio frequency band (e.g., FM or AM bands), such as waveform 424 of FIG. 4B. The radio receiver is equipped with suitable circuitry/signal processing algorithms to detect the abnormal signal and its fundamental frequency. (Note that an abnormal waveform embodied as a clipped signal such as in FIG. 4B has a fundamental frequency which is the same frequency as the original, non-clipped signal as shown in FIG. 4A, plus harmonic frequencies and possibly other distortion-generating frequencies.)

When a signal having an abnormal waveform has not been received, the radio receiver ends the present algorithm. At this point, the radio receiver may detect only a broadcast signal of a radio frequency selected by the user to reproduce radio broadcasting, as in the method of FIG. 1.

In contrast, when a signal having an abnormal waveform has been received, the radio receiver proceeds to step 205 to determine the fundamental radio frequency of, or corresponding to, the abnormal waveform, which identifies the frequency at which a different radio receiver is tuned (i.e., the radio receiver that transmitted the abnormal signal). (If the abnormal waveform is designed as a particular harmonic of the original radio frequency, the fundamental radio frequency is determined as a frequency corresponding to the harmonic.)

For example, one way to detect and distinguish an abnormal waveform is by the radio receiver pre-storing a negative portions waveform to be expected for each radio frequency in an operating band (e.g., a licensed FM or AM band). Accordingly, the radio receiver can compare the stored negative portions waveforms with the received negative portions waveform to determine the fundamental frequency of the received abnormal signal As another example, the radio receiver compares a signal of each radio frequency received in step 201 with the waveform of the abnormal waveform signal to determine the radio frequency having the same negative portions waveform as the signal having the abnormal waveform. When a plurality of signals having the abnormal waveform exist, the radio receiver determines a radio (carrier) frequency corresponding to each abnormal waveform.

After determining the radio frequency having the same fundamental frequency as that of the abnormal waveform, the radio receiver proceeds to step 207 to display information regarding the radio frequency determined in step 205 on a display unit so that the user may view the information.

The radio receiver proceeds to step 209 to determine whether the user requests to listen to the radio frequency determined in step 205. When the user does not request to listen to the radio frequency determined in step 205, the radio receiver ends the present algorithm.

In contrast, when the user requests to listen to the radio frequency determined in step 205, the radio receiver proceeds to step 211 to reproduce broadcasting of the relevant radio frequency. For example, the radio receiver may detect only broadcast signals of the radio frequency that the user has requested to listen to and reproduce radio broadcasting as in the method of FIG. 1.

In the above-described embodiment of the present invention, when the user requests to listen to a radio broadcast at a radio frequency corresponding to a receive signal having an abnormal waveform (e.g., via selection of that radio frequency on a display), the radio receiver reproduces broadcasting of the relevant radio frequency.

In an alternative exemplary embodiment or additional operating mode, when one radio frequency corresponding to a signal having an abnormal waveform exists, the radio receiver immediately reproduces broadcasting of the relevant radio frequency without waiting for the user's command.

Hereinafter, a construction of a radio receiver for reproducing radio broadcasting, and searching for a radio frequency that a different radio receiver is listening to is described.

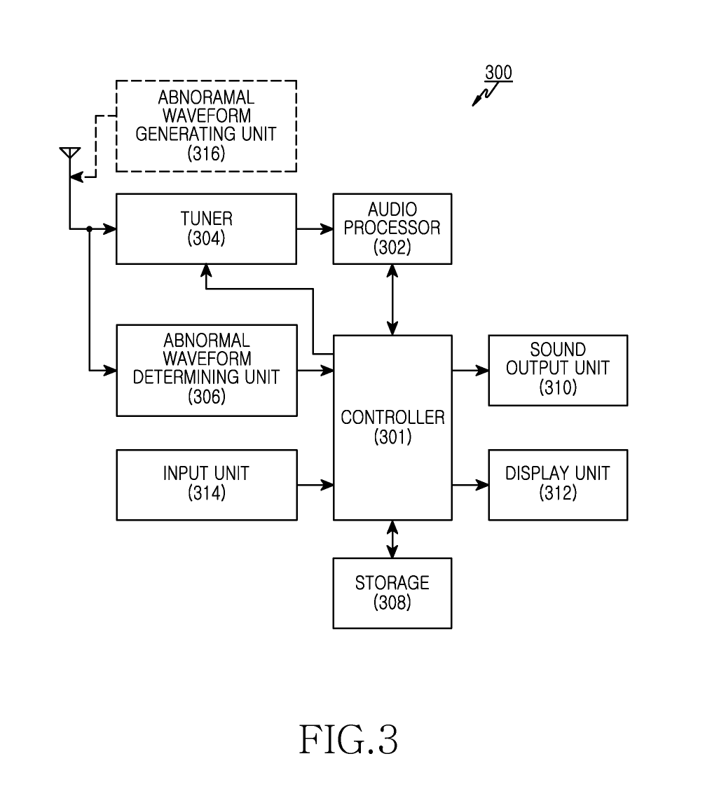

FIG. 3 is a block diagram illustrating a radio receiver according to an exemplary embodiment of the present invention.

As illustrated in FIG. 3, the radio receiver 300 includes a controller 301, an audio processor 302, a tuner 304, an abnormal waveform determining unit 306, a storage 308, a sound output unit 310, a display unit 312, and an input unit 314. If the radio receiver 300 is designed to transmit abnormal waveforms to other radio receivers, it includes an abnormal waveform generating unit 316, which is coupled to the tuner 304 and a transmitting antenna (which may be the same as the receive antenna, using suitable isolation measures).

The controller 301 controls an overall operation of the radio receiver 300. For example, the controller 301 controls the tuner 304 to detect broadcast signals of a radio frequency that a user desires to listen to; controls outputting of audio data provided from the audio processor 302 via the sound output unit 310; and detects a radio frequency having the same negative portions waveform as a negative portions waveform provided from the abnormal waveform determining unit 306, as in the method of r FIG. 2 described earlier.

The tuner 304 detects and outputs only signals of a radio frequency that the user desires to listen to among broadcast signals received via an antenna under control of the controller 301.

The audio processor 302 decodes a broadcast signal provided from the tuner 304 to generate audio data to reproduce the radio broadcast for the user.

The abnormal waveform determining unit 306 determines whether a signal including a predetermined distorted waveform, such as a waveform with only negative portions, exists among broadcast signals received via the antenna.

The storage 308 may include a program storage for storing a program for controlling an operation of the radio receiver and a data storage for storing data occurring during execution of a program. For example, the storage 308 stores a negative portions waveform of each radio frequency.

The sound output unit 310 decodes audio data generated by the audio processor 302, amplifies and outputs the same to the outside under control of the controller 301.

The display unit 312 displays state information of the radio receiver, information of a reproduced radio frequency, information of a radio frequency that a different radio receiver listens to, etc.

The input unit 314 provides input data generated by a user's selection to the controller 300. For example, the input unit 314 provides information of a radio frequency that the user has selected to listen to, to the controller 300.

The abnormal waveform generating unit 316 is configured to generate an abnormal signal derived from energy of the received radio signal, and to transmit the abnormal signal as a broadcast to other radio receivers to enable the other radio receivers to discern the radio frequency that the radio receiver 300 is currently receiving. Thus, users of the other radio receivers may then opt to tune to the radio frequency corresponding to the abnormal signal.

As described above, the controller 301 detects a radio frequency having the same negative portions waveform as a negative portions waveform provided by the abnormal waveform determining unit 306. For example, the controller 301 compares a negative portions waveform of each radio frequency stored in the storage 308 with the negative portions waveform provided from the abnormal waveform determining unit 306 to detect a relevant radio frequency. As another example, the controller 301 may compare a negative portions waveform of each radio frequency received together with a signal having the abnormal waveform with the negative portions waveform provided from the abnormal waveform determining unit 306 to detect a relevant radio frequency.

In other words, in exemplary methods and apparatus according to the present invention for searching for a radio frequency in a radio receiver, a received broadcast signal is analyzed to determine if it has an abnormal waveform. If so, a detection of a fundamental radio frequency corresponding to the abnormal waveform is made. This detection may involve comparing characteristics of the received broadcast signal to those of at least one pre-stored waveform in storage 308 representing an abnormal waveform. Storage 308 may pre-store a plurality of waveforms, each corresponding to a different radio frequency in the radio frequency band (e.g., FM or AM band). In this case, characteristics of the received broadcast signal are compared to those of each pre-stored waveform to determine the closest match, and thereby detect the correct radio frequency corresponding to the abnormal waveform.

If a plurality of abnormal waveforms are detected, this is an indication that abnormal signals from a plurality of other radio receivers have been received. The fundamental radio frequencies derived from the plurality of abnormal waveforms may then be displayed, enabling the user to select from among the radio frequencies and tune to radio stations to which other radio listeners are currently tuned. As described above, according to an exemplary embodiment of the present invention, a radio receiver has an advantage of easily sharing radio listen information with other people by automatically searching for a radio frequency that other people listen to.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A method for searching for a radio frequency in a radio receiver, the method comprising:
determining if a received broadcast signal has an abnormal waveform; and
detecting a fundamental radio frequency corresponding to the received broadcast signal if it has the abnormal waveform.

2. The method of claim 1, wherein determining if the received broadcast signal has an abnormal waveform comprises determining if the broadcast signal is a waveform including only negative peaks.

3. The method of claim 1, wherein determining if the received broadcast signal has an abnormal waveform comprises:
comparing characteristics of the received broadcast signal to those of at least one stored waveform representing an abnormal waveform.

4. The method of claim 3, wherein comparing characteristics comprises comparing characteristics of the received broadcast signal to those of each of a plurality of stored waveforms to determine if a match exists, wherein each stored waveform corresponds to a different radio frequency in a radio frequency band, and,
detecting a fundamental radio frequency comprises determining which of the stored waveforms most closely matches the received broadcast signal.

5. The method of claim 1, further comprising reproducing radio broadcasting of the detected fundamental radio frequency by tuning the radio receiver to the fundamental radio frequency.

6. The method of claim 5, wherein the reproducing of the radio broadcasting further comprises:
receiving a radio broadcast signal of the detected radio frequency;
dividing the radio broadcast signal into positive portions and negative portions; and
amplifying only the positive portions to reproduce the radio broadcasting.

7. The method of claim 6, further comprising transmitting the negative portions from the radio receiver as an abnormal signal broadcast to other radio receivers.

8. The method of claim 1, further comprising:
displaying information of the detected radio frequency on a display unit; and
when a user selection for the displayed radio frequency is received, reproducing radio broadcasting of the radio frequency.

9. The method of claim 8, wherein reproducing radio broadcasting comprises:
displaying a plurality of radio frequencies, each corresponding to a different abnormal waveform received;
receiving a user selection for one of the displayed radio frequencies; and
reproducing radio broadcasting of the selected radio frequency.

10. The method of claim 8, wherein the reproducing of the radio broadcasting comprises:
receiving a broadcast signal of the detected radio frequency;
dividing the broadcast signal into positive portions and negative portions;
amplifying the positive portions to reproduce the radio broadcasting; and
transmitting the negative portions from the radio receiver as an abnormal signal broadcast to other radio receivers.

11. An apparatus for searching for a radio frequency in a radio receiver, the apparatus comprising:
an abnormal waveform signal determining unit to determine if a received broadcast signal has an abnormal waveform; and
a controller to detect a fundamental radio frequency corresponding to the received broadcast signal if it has the abnormal waveform.

12. The apparatus of claim 11, wherein the received broadcast signal is determined to have the abnormal waveform if it is determined to contain only negative peaks, and the apparatus further comprising a storage for storing an abnormal signal waveform associated with each radio frequency of a plurality of radio frequencies,
wherein the controller compares the signal waveform of each radio frequency stored in the storage with a negative portions waveform of the broadcast signal including only the negative portions to detect a radio frequency having the same negative portions waveform as the broadcast signal including only the negative portions.

13. The apparatus of claim 12, wherein the controller compares a signal waveform of each radio frequency received via an antenna with a negative portions waveform of the broadcast signal including only the negative portions to detect the radio frequency having the same negative portions waveform as the broadcast signal including only the negative portions.

14. The apparatus of claim 11, wherein the controller controls to reproduce radio broadcasting of the detected radio frequency.

15. The apparatus of claim 12, further comprising a tuner for receiving a broadcast signal corresponding to the radio frequency detected by the controller, wherein the controller divides the broadcast signal received via the tuner into a positive portions and a negative portions, and amplifies the positive portions to reproduce radio broadcasting.

16. The apparatus of claim 15, wherein the controller transmits a negative portions waveform of the broadcast signal received via the tuner from the radio receiver to other radio receivers as an abnormal signal broadcast.

17. The apparatus of claim 11, further comprising a display unit for displaying information of the detected radio frequency, and the controller is further configured to detect a user selection of the detected radio frequency, and in response to detecting the user selection, to control reproduction of the radio broadcasting of the radio frequency.

18. The apparatus of claim 11, further comprising a display unit for displaying information of the detected radio frequency, wherein when a plurality of radio frequencies displayed on the display unit exist, the controller reproduces radio broadcasting of one radio frequency that a user requests to listen to among the plurality of radio frequencies displayed on the display unit.

19. The apparatus of claim 11, further comprising an abnormal signal generating unit configured to generate an abnormal signal derived from energy of a received radio signal, and to transmit the abnormal signal as a broadcast to other radio receivers to enable the other radio receivers to discern the radio frequency that the apparatus is receiving.

20. A mobile terminal comprising a radio receiver, the radio receiver comprising:
an abnormal waveform signal determining unit to determine if a received broadcast signal has an abnormal waveform; and
a controller to detect a fundamental radio frequency corresponding to the received broadcast signal if it has the abnormal waveform.
